(19) United States
(12) Patent Application Publication
(10) Pub. No.: US 2026/0197443 A1
(43) Pub. Date: Jul. 9, 2026

(54) PARTITION MODE DECISION FOR VIDEO CODING WITH LITE MULTILAYER PERCEPTRON

(71) Applicants: CITY UNIVERSITY OF HONG KONG, Hong Kong (CN); LINGNAN UNIVERSITY, Hong Kong (CN)

(72) Inventors: Sam Tak Wu KWONG, Hong Kong (CN); Shiqi WANG, Hong Kong (CN); Zhenhao SUN, Hong Kong (CN)

(21) Appl. No.: 19/011,830

(22) Filed: Jan. 7, 2025

(51) Int. Cl. H04N 19/107; H04N 19/119; H04N 19/124; H04N 19/147

(52) U.S. Cl. CPC H04N 19/107; H04N 19/119; H04N 19/124; H04N 19/147

(57) ABSTRACT

A computer-implemented method for making fast partitioning decision on a block of a frame of a video. The method includes the steps of a) identifying, for the block, a plurality of partition modes; b) for one of the plurality of partition modes, predicting a RD cost resulted from partitioning the block using the partition mode; c) performing partitioning using the partition mode, if the RD cost indicates an improved RD performance; d) skipping the partition mode if the RD cost does not indicate an improved RD performance; and repeating steps c) and d) for each one of the plurality of partition modes. By incorporating the lightweight partition decision model into the encoder, the encoding complexity is significantly reduced with negligible RD performance degradation.

### FIELD OF INVENTION

This invention relates to video coding, and in particular to optimization of video encoders.

### BACKGROUND OF INVENTION

The Versatile Video Coding (H.266/VVC) standard [1], as the successor to High Efficiency Video Coding (H.265/HEVC) [2], marks a significant advancement in video compression technology, offering nearly a 50% bitrate reduction for comparable video quality. H.266/VVC enhances coding efficiency at the expense of increased computational complexity, resulting in approximately eight times higher complexity compared to H.265/HEVC [1]. This surge of complexity has spurred research into optimization techniques across various encoding dimensions to reduce encoding complexity without sacrificing coding efficiency. The binary tree (BT) and multitype tree (MTT) partitioning strategy, as a key feature of the latest video standard, demands considerable computational resources during a recursive search to achieve optimal rate distortion (RD) performance, as in the example shown in FIG. 1. Such an advanced partition technique brings a surging computational overhead, which is caused by searching for an optimal partition structure during the encoding phase. The high computational complexity of an exhaustive search prompts investigations into reducing the complexity of flexible BT and MTT partitioning schemes.

The existing fast partition skipping employed in encoders is mainly based on the intrinsic properties of the block and the current partitioning. This often requires extensive trials to determine suitable criteria. On the other hand, this approach lacks a clear optimization objective, such as improving the RD performance.

### REFERENCES

The following references are referred to throughout this specification, as indicated by the numbered brackets. The disclosures of each of these references are hereby incorporated by reference herein in their entireties for all purposes.
[1] B. Bross, Y.-K. Wang, Y. Ye, S. Liu, J. Chen, G. J. Sullivan, and J.-R. Ohm, “Overview of the versatile video coding (VVC) standard and its applications,” IEEE Trans. on Circuits and Syst, for Video Technol., vol. 31, no. 10, pp. 3736-3764 August 2021.
[2] G. J. Sullivan, J.-R. Ohm, W.-J. Han, and T. Wiegand, “Overview of the high efficiency video coding (HEVC) standard,” IEEE Trans. on Circuits and Syst, for Video Technol., vol. 22, no. 12, pp. 1649-1668 September 2012.
[3] T. Zhao, H. Wang, S. Kwong, and S. Hu, “Probability-based coding mode prediction for H.264/AVC,” in Proc. IEEE Int. Conf. on Image Process. (ICIP), 2010, pp. 3389-3392.
[4] X. Liu, Y. Li, D. Liu, P. Wang, and L. T. Yang, “An adaptive CU size decision algorithm for HEVC intra prediction based on complexity classification using machine learning,” IEEE Trans. Circuits Syst. Video Technol., vol. 29, no. 1, pp. 144-155, 2017.
[5] Z. Wang, S. Wang, X. Zhang, S. Wang, and S. Ma, “Fast QTBT partitioning decision for interframe coding with convolution neural network,” in Proc. IEEE Int. Conf. on Image Process. (ICIP). IEEE, 2018, pp. 2550-2554.
[6] M. Wang, J. Li, L. Zhang, K. Zhang, H. Liu, S. Wang, S. Kwong, and S. Ma, “Extended quad-tree partitioning for future video coding,” in Proc. IEEE Data Compress. Conf. (DCC), 2019, pp. 300-309.
[7] M. Lei, F. Luo, X. Zhang, S. Wang, and S. Ma, “Look-ahead prediction based coding unit size pruning for VVC intra coding,” in Proc. IEEE Int. Conf. on Image Process. (ICIP), 2019, pp. 4120-4124.
[8] A. Wieckowski, J. Ma, H. Schwarz, D. Marpe, and T. Wiegand, “Fast partitioning decision strategies for the upcoming versatile video coding (VVC) standard,” in Proc. IEEE Int. Conf. on Image Process. (ICIP), September 2019, pp. 4130-4134.
[9] H. Yang, L. Shen, X. Dong, Q. Ding, P. An, and G. Jiang, “Low-complexity CTU partition structure decision and fast intra mode decision for versatile video coding,” IEEE Trans. Circuits Syst. Video Technol., vol. 30, no. 6, pp. 1668-1682 March 2019.
[10] J. Cui, T. Zhang, C. Gu, X. Zhang, and S. Ma, “Gradient-based early termination of CU partition in VVC intra coding,” in Proc. IEEE Data Compres. Conf. (DCC), March 2020, pp. 103-112.
[11] M. Saldanha, G. Sanchez, C. Marcon, and L. Agostini, “Fast partitioning decision scheme for versatile video coding intra-frame prediction,” in Proc. IEEE Int. Symp. Circuts Syst. (ISCAS), October 2020, pp. 1-5.
[12] G. Tech, J. Pfaff, H. Schwarz, P. Helle, A. Wieckowski, D. Marpe, and T. Wiegand, “Fast partitioning for VVC intra-picture encoding with a CNN minimizing the rate-distortion-time cost,” in Proc. IEEE Data Compress. Conf. (DCC), 2021, pp. 3-12.
[13] Q. He, W. Wu, L. Luo, C. Zhu, and H. Guo, “Random forest based fast CU partition for VVC intra coding,” in Proc. IEEE Int. Symp. Broadband Multimed. Syst, and Broadcast. (BMSB), August 2021, pp. 1-4.
[14] J. Zhang, M. Wang, C. Jia, Q. Wang, S. Wang, S. Ma, and W. Gao, “Fast partition mode decision via a plug-in fully connected network for video coding,” in Proc. IEEE Data Compress. Conf. (DCC), 2022, pp. 222-231.
[15] T. Zhao, Y. Huang, W. Feng, Y. Xu, and S. Kwong, “Efficient VVC intra prediction based on deep feature fusion and probability estimation,” IEEE Trans. Multimed., September 2022.
[16] A. Tissier, W. Hamidouche, S. B. D. Mdalsi, J. Vanne, F. Galpin, and D. Menard, “Machine learning based efficient QT-MTT partitioning scheme for VVC intra encoders,” IEEE Trans. Circuits Syst. Video Technol., January 2023.
[17] H. Wang and S. Kwong, “Hybrid model to detect zero quantized DCT coefficients in H. 264,” IEEE Trans. Multimed., vol. 9, no. 4, pp. 728-735, May 2007.
[18] X. Ji, S. Kwong, D. Zhao, H. Wang, C.-C. J. Kuo, and Q. Dai, “Early determination of zero-quantized 8×8 DCT coefficients,” IEEE Trans. Circuits Syst. Video Technol., vol. 19, no. 12, pp. 1755-1765 July 2009.
[19] H. Wang, H. Du, W. Lin, S. Kwong, O. C. Au, J. Wu, and Z. Wei, “Early detection of all-zero 4×4 blocks in high efficiency video coding,” J. Vis. Commun. Image Represent., vol. 25, no. 7, pp. 1784-1790 October 2014.
[20] H. Fan, R. Wang, L. Ding, X. Xie, H. Jia, and W. Gao, “Hybrid zero block detection for high efficiency video coding,” IEEE Trans. Multimed., vol. 18, no. 3, pp. 537-543, January 2016.
[21] J. Cui, R. Xiong, X. Zhang, S. Wang, S. Wang, S. Ma, and W. Gao, “Hybrid all zero soft quantized block detection for HEVC,” IEEE Trans. Image Process., vol. 27, no. 10, pp. 4987-5001 May 2018.
[22] Z. Sun, M. Wang, P. Chen, X. Wang, S. Wang, and S. Kwong, “Revisiting all-zero block detection for versatile video coding,” IEEE Trans. on Circuits and Syst, for Video Technol., January 2024.
[23] A. Wieckowski, J. Brandenburg, T. Hinz, C. Bartnik, V. George, G. Hege, C. Helmrich, A. Henkel, C. Lehmann, C. Stoffers et al., “VVenC: An open and optimized VVC encoder implementation,” in Proc. IEEE Int. Conf. on Multimed. & Expo Workshops, July 2021, pp. 1-2.

### SUMMARY OF INVENTION

Accordingly, the present invention, in one aspect, is a computer-implemented method for making fast partitioning decision on a block of a frame of a video. The method includes the steps of a) identifying, for the block, a plurality of partition modes; b) for one of the plurality of partition modes, predicting a RD cost resulted from partitioning the block using the partition mode; c) performing partitioning using the partition mode, if the RD cost indicates an improved RD performance; d) skipping the partition mode if the RD cost does not indicate an improved RD performance; and repeating steps c) and d) for each one of the plurality of partition modes.

In some embodiments, predicting the RD cost in Step b) is based on a plurality of features of the block.

In some embodiments, the block is a coding unit (CU); the plurality of features of the block comprising a AZB (all-zero block) feature, CU size features, partition features, and context features.

In some embodiments, the RD cost is represented in a binary value, which indicates either the improved RD performance or no improvement in RD performance.

In some embodiments, step b) is conducted using a multilayer perceptron (MLP) model.

In some embodiments, a plurality of features of the block that is contacted as a feature vector, is provided to the MLP model in Step b) as input.

In some embodiments, the MLP model includes two densely connected layers, with their neuron counts set to 32 and 16 respectively.

In some embodiments, the MLP model is trained using multiple datasets with different quantization parameters.

In some embodiments, all feasible feature combinations of the plurality of features is explored to obtain predictive outcomes, where the predictive outcomes are stored in an video encoder that is adapted to carry out the computer-implemented method.

In some embodiments, the plurality of partition modes includes one or more of quadtree (QT), horizontal binary tree (HBT), vertical binary tree (VBT), horizontal ternary tree (HTT) and vertical ternary tree (VTT).

In some embodiments, the method further includes, before Step c), a step of detecting if the block is an AZB.

In some embodiments, the method further includes, before the step of step of detecting if the block is an AZB, a step of choosing either an intra-prediction model or an inter-prediction model for encoding the block and generating a residue signal for the step of detecting if the block is an AZB.

According to another embodiment of the invention, there is provided a non-transitory computer-readable memory recording medium having computer instructions recorded thereon. The computer instructions, when executed on one or more processors, causing the one or more processors to perform operations according to the method as mentioned above.

According to a further embodiment of the invention, there is provided a computing system that includes one or more processors, and a memory containing instructions that, when executed by the one or more processors, cause the computing system to perform operations according to the method as mentioned above.

One can see that exemplary embodiments of the invention therefore provide a partition decision method for fast partitioning in video coding, based on a MLP model. Several features, such as whether the current block is an AZB, the size of the current block, the partition depth, etc., are used to predict whether the current partition will lead to better RD performance. This approach allows one to leverage not only the presence of AZB but also other relevant features, paving the way for more informed and efficient encoding strategies compared to heuristic-based approaches. By incorporating the lightweight partition decision model into the encoder, the encoding complexity is significantly reduced with negligible RD performance degradation.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows an example of BT and MTT partition in H.266/VVC [1].

FIG. 2 shows a partition decision MLP model according to one embodiment of the invention.

FIG. 3 shows steps of a method for making fast partitioning decision on a CU of a frame of a video according one embodiment of the invention.

FIG. 4a illustrates experimental results of encoding time savings of the method in FIG. 3 across four QPs (22, 27, 32, 37) among different sequence for Class A.

FIG. 4b illustrates experimental results of encoding time savings of the method in FIG. 3 across four QPs (22, 27, 32, 37) among different sequence for Class B.

FIG. 4c illustrates experimental results of encoding time savings of the method in FIG. 3 across four QPs (22, 27, 32, 37) among different sequence for Class C.

FIG. 4d illustrates experimental results of encoding time savings of the method in FIG. 3 across four QPs (22, 27, 32, 37) among different sequence for Class D.

FIG. 4e illustrates experimental results of encoding time savings of the method in FIG. 3 across four QPs (22, 27, 32, 37) among different sequence for Class E.

### DETAILED DESCRIPTION

In a first embodiment of the invention, there is described a low-complexity CU partition decision making method for H.266/VVC encoder. The method employs lightweight multilayer perceptrons that analyze specific feature patterns to predict a potential rate-distortion performance improvement after partition. Based on the model's prediction, the encoder could early determine the partitioning for a CU (which is a block of the video frame). In an experimental setup, the method is integrated into the enhanced H.266/VVC, VVenC version 1.7.0, showcasing its practical applicability. The experimental results show that the method achieves 17.55% complexity reduction with 1.75% BDBR (Bjontegaard delta bitrate) increasing under random access configuration.

Before describing the above-mentioned embodiment in detail, some background information will be provided first. Deciding to skip a partition involves leveraging the correlation between the features of a CU and a specific partition mode. This evaluation determines whether the ongoing partition should be executed [3]-[16]. On the other hand, identifying AZB before the transform and quantitation phases could accelerate the encoding process. The AZBs contain no nonzero coefficient such that the encoder can skip redundant computations and thereby accelerating the encoding process [17]-[22]. In recent researches, researchers have developed techniques to identify genuine all-zero blocks (GAZB) and pseudo all-zero blocks (PAZB) in video encoding. In [19], a novel algorithm identifies all-zero 4×4 blocks using theoretical analyses of the 4×4 DCT and quantization for H.265/HEVC. In [20], two bounds based on SAD and SATD thresholds were derived. Cui et al. enhanced AZB detection with soft-decision quantization and SATD-based early termination, and proposed RD models and an adaptive search mechanism for better PAZB classification in H.265/HEVC. In [22], the authors extend the AZB detection method to non-square block cases. Specifically, a residual block of size M×N, denoted as SADᵣₑₛᵢ, is categorized as an AZB if it meets the criteria in the following formula:

$$S A {D}_{r e s i} < {θ}_{f} \cdot \frac{{( M \times N )}^{\frac{3}{2}}}{3 m \sqrt{2 ϕ}} . \qquad ( 1 )$$

In the above formulation, φ represents the maximum item in correlation matrix

$${[ {R}_{M}^{′} ]}_{( u , u )} \cdot {[ {R}_{N}^{′} ]}_{( v , v )} ,$$

and θ_{f} is formulated as

$${θ}_{f} = 5 << ( 13 + {M}_{\frac{Q P}{6}} ) ,$$

where

$${M}_{\frac{Q P}{6}}$$

is a scaling factor using integer quantization implementation.

In VVC, each picture or video frame is first split into non-overlapping squares called coding-tree units (CTUs). The largest CTU size allowed in VVC is 128×128 pixels, larger than the 64×64 maximum size allowed in HEVC. Large blocks improve the efficiency of coding flat areas such as backgrounds, especially for high-resolution videos such as HD and 4K. In order to efficiently represent highly detailed areas such as textures and edges, VVC employs a flexible partitioning scheme that can partition 128×128-sized CTUs down to CUs. The partitioning of a CTU may use various types of splits that are defined in VVC. For example, a block partition structure in VVC can include a quad-tree (QT) splits, binary tree (BT) splits and ternary tree (TT) splits. The block partitioning strategy in VCC is referred to as QT plus multi-type tree (MTT) (QT+MTT) strategy. A smaller can be a leaf node of the split and can be processed as a CU.

The various types of splits can be used for further partitioning a CU into PUs (prediction units), or a CU into TUs (transformation units), and so on. For example, the binary tree can be used for partitioning a CTU into CUs, where the root node of the binary tree is a CTU and the leaf node of the binary tree is CU. In an example, for a CTU (coding tree unit) with 128×128 samples, the QT may be first performed to obtain four 64×64 child CUs. The child CUs are then recursively partitioned with the quadtree with multitype tree (QT-MTT) scheme to attain sub-CUs. After these processes a plurality of CUs can be defined for the VVC.

TABLE I
The percentage of CUs where the RD performance does not improve
after partition. The information is gathered from the BasketballDrive
sequence under random access configuration.

| Type | Feature | QP 22 | QP 27 | QP 32 | QP 37 |
|---|---|---|---|---|---|
| AZB | AZB | 33.55% | 23.99% | 16.90% | 11.38% |
| | non-AZB | 27.46% | 18.99% | 13.64% | 9.52% |
| CU | 64 × 64 | 21.41% | 27.88% | 33.41% | 36.39% |
| size | 32 × 32 | 41.42% | 46.83% | 50.33% | 56.52% |
| feature | 16 × 16 | 59.54% | 64.69% | 69.76% | 75.42% |
| | 8 × 8 | 84.10% | 86.94% | 90.06% | 92.61% |
| | 4 × 4 | 95.93% | 93.19% | 90.61% | 88.06% |
| Partition | Depth 0 | 13.66% | 35.62% | 45.57% | 51.94% |
| features | Depth 1 | 20.45% | 25.80% | 29.38% | 32.63% |
| | Depth 2 | 40.20% | 45.46% | 49.60% | 55.50% |
| | Depth 3 | 54.63% | 59.50% | 63.40% | 68.67% |
| | Depth 4 | 68.64% | 72.67% | 77.24% | 82.23% |
| | Depth 5 | 79.82% | 82.00% | 84.92% | 87.65% |
| | Depth 6 | 88.17% | 85.39% | 83.50% | 82.37% |
| | Split QT | 41.46% | 30.57% | 23.79% | 19.58% |
| | Split HBT | 74.58% | 77.30% | 80.29% | 83.31% |
| | Split VBT | 72.16% | 74.23% | 76.88% | 80.07% |
| | Split HTT | 67.08% | 61.27% | 55.98% | 52.21% |
| | Split VTT | 67.85% | 59.63% | 52.34% | 47.31% |
| Context | ReusingCu-1 | 22.89% | 15.86% | 11.20% | 7.68% |
| features | ReusingCu-0 | 32.55% | 23.40% | 16.65% | 11.33% |
| | didHorSplit-1 | 10.01% | 7.86% | 6.37% | 5.06% |
| | didHorSplit-0 | 59.89% | 52.87% | 45.86% | 38.12% |
| | didVerSplit-1 | 10.18% | 8.00% | 6.47% | 5.16% |
| | didVerSplit-0 | 57.46% | 49.84% | 42.50% | 34.23% |
| | BestNoSplit-1 | 46.73% | 36.29% | 25.62% | 16.63% |
| | BestNoSplit-0 | 29.86% | 20.64% | 14.29% | 9.57% |

Next, a preliminary analysis to evaluate the RD efficiency improvements after partition for different CUs is conducted. As illustrated in Table I, the varying proportions of cases exhibiting RD improvement across different features are demonstrated. The numbers in the table indicate the probability that partitioning does not reduce RD cost under the premise that the current CU has the current feature. As an example, when using QP 22 configuration, it was observed that approximately 33.55% of the AZB CUs did not show any improvement in their RD cost after partition, whereas the percentage of non-AZB CUs with no improvement was smaller (27.46%). Similar relationships can also be identified among various other characteristics. Based on these observations, it indicates that it is possible to utilize a model to predict the requirement of partitioning in determining the most effective RD configuration, considering a specific set of features. The selected features can be classified into four categories, including AZB (‘azb flag’), CU size features (‘width’ and ‘height’), partition features (‘current depth’, ‘current best mode’, ‘split type’ and ‘min depth’) and context features (‘ReusingCu’, ‘didHorSplit’, ‘didVerSplit’ and ‘BestNoSplit’). Based on the best RD cost before and after partitioning of the current coding unit, a binary label ‘rd improved’ is introduced to represent the necessity of attempting the current partition mode. A positive label represents the RD cost will reduce after partition, and a negative label represents the RD cost does not reduce. The binary label is therefore a binary value indicating whether there is improvement in RD performance.

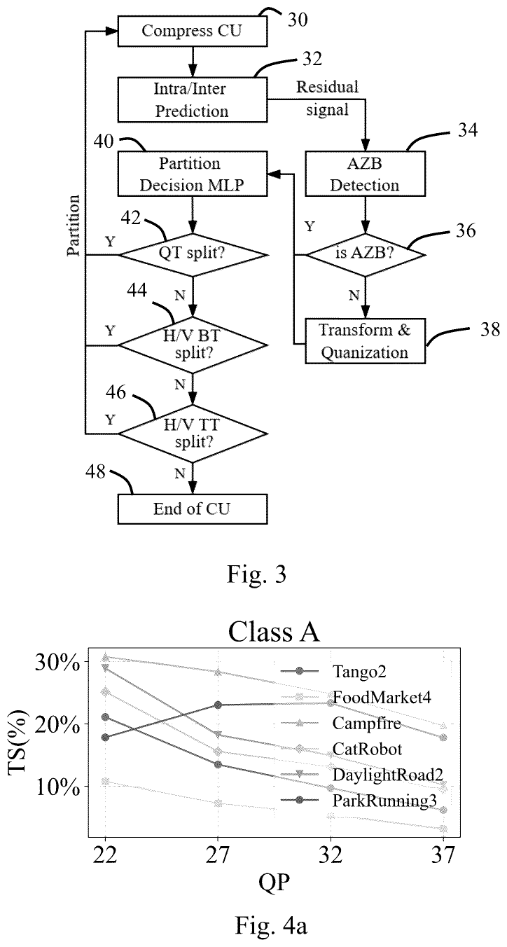

Leveraging the above features, in this embodiment a lightweight MLP is devised to identify patterns among these features to predict potential improvements in RD cost. As shown in FIG. 2, the four categories of features are contacted as a feature vector and fed into a MLP model. The model is composed of two densely connected layers 20, 22 with neuron counts set to 32 and 16, respectively. The output of MLP model is a binary prediction 24 indicating whether the RD performance will improve after current partition is executed. For model training, features derived from the BasketballDrive sequence are utilized, with four distinct models corresponding to four quantization parameters: 22, 27, 32, and 37. The performance of this model is measured through various metrics, including model accuracy and the F-score across two labels, F1 (0) and F1 (1). As shown in Table II, these evaluation metrics validate the model's proficiency in making partition decisions. Given the finite and discrete nature of the features employed, an exhaustive exploration of all feasible feature combinations is conducted to obtain all predictive outcomes. These predictions are subsequently stored as an array and embedded in the encoder to facilitate expedited inference during the encoding phase.

TABLE II
Performance evaluation of the lightweight MLP model for
predicting whether the RD performance improve after partition.
F₁ (0) and F₁ (1) represent the F-score for negative
label and positive label, respectively.

| QP | Samples | Accuracy | F₁ (0) | F₁ (1) |
|---|---|---|---|---|
| 22 | 4,289,352 | 0.88 | 0.81 | 0.91 |
| 27 | 2,198,105 | 0.90 | 0.76 | 0.93 |
| 32 | 1,239,230 | 0.92 | 0.72 | 0.95 |
| 37 | 696,594 | 0.94 | 0.67 | 0.96 |

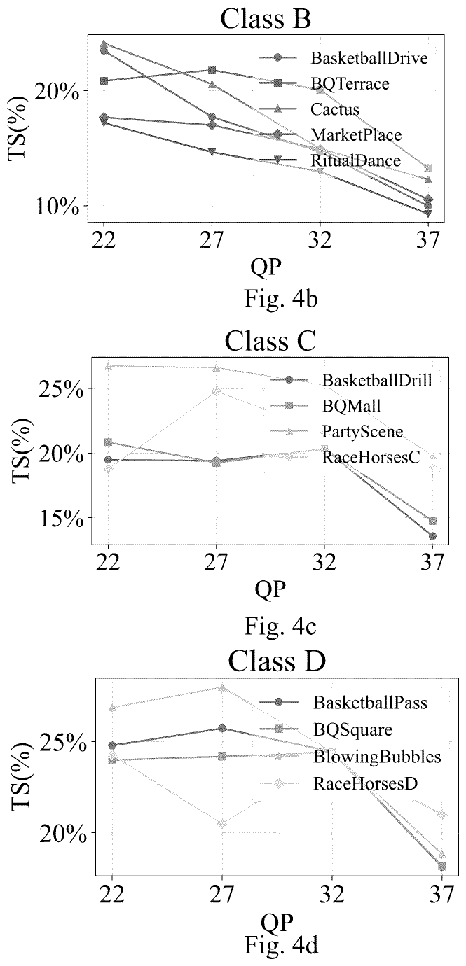

The workflow of a method for making fast partitioning decision on a block of a frame of a video is illustrated in FIG. 3, which demonstrates the procedural steps of partition skip for a CU as the block using VVC as an example. Specifically, the CU partition decision approach is built with a classification model which may be the MLP model illustrated in FIG. 2. However, it should be pointed out that the MLP model illustrated in FIG. 2 is not the only model that may be applied in the method of FIG. 3, in particular as the various categories of features shown in FIG. 2 are not limiting. Rather, a different multilayer perceptrons model that takes the same or different categories of features than those in FIG. 2 can be used.

Before the method in FIG. 3 is carried out, the frame of the video is firstly partitioned by the video encoder into a plurality of CTUs which is well-known to skilled person. As the skilled persons would understand, the encoder can choose the best division of the CTU blocks based on the content of the CTU block, for example in a rather uniform area, bigger CTU blocks are more efficient. Whereas in areas with edges or more detail, smaller CTU blocks are typically chosen. After the CTUs are obtained, each CTU may further be partitioned down to CUs using the flexible partitioning scheme as mentioned above that VVC supports.

For a particular CU, the method shown in FIG. 3 then comes to play. It should be noted that the method shown in FIG. 3 will be conducted separately for each of the CUs partitioned from CTUs. The method starts at Step 30 where the CU encoding process starts. In Step 32, for the CU a prediction is performed and a residual signal is obtained. The prediction is generated by inter prediction or by intra prediction by choosing an intra/inter prediction model. While the former makes use of temporal redundancies, the latter exploits spatial correlations to generate the prediction signal for a CU out of previously reconstructed samples of the same frame that are located close to the current samples.

In Step 34, the AZB detection is conducted on the residual signal. The AZB detection method can be chosen from any applicable methods, such as those mentioned in [19]-[22]. The AZB detection method is conducted to determine in Step 36 whether the current CU will be quantized to zero. If the current CU is an AZB, the feature ‘azb flag’ is set as positive, and Step 38 will be skipped while the method turns directly to Step 40. Otherwise, if the current CU is not an AZB, the feature ‘azb flag’ is set as negative, and the method proceeds to Step 38, in which the residual signal is transformed and quantized and the transform coefficients are entropy coded, as understood by skilled persons in the art.

Irrespective of whether Step 38 is conducted or not, the method goes to Step 40 in which the partition decision MLP model is applied. The features mentioned above, which include AZB (‘azb flag’), CU size features (‘width’ and ‘height’), partition features (‘current depth’, ‘current best mode’, ‘split type’ and ‘min depth’) and context features (‘ReusingCu’, ‘didHorSplit’, ‘didVerSplit’ and ‘BestNoSplit’), are then combined to form a feature vector. In the original, default encoding process in VVC, the encoder will recursively attempt each partition mode, including QT, HBT, VBT, HTT and VTT. These partitioning modes were identified in advance, for example as they are available partitioning modes for the VVC encoder. However, compared with standard VVC partitioning method for CUs, with the method in FIG. 3 the classification model (which could be the MLP model in FIG. 2) is applied to predict whether the RD cost will decrease for each partition mode. If the RD performance improves, the correspondence partition mode will be performed. Otherwise, the current mode will be skipped, and then the encoder will try the next mode until all partition modes are traversed.

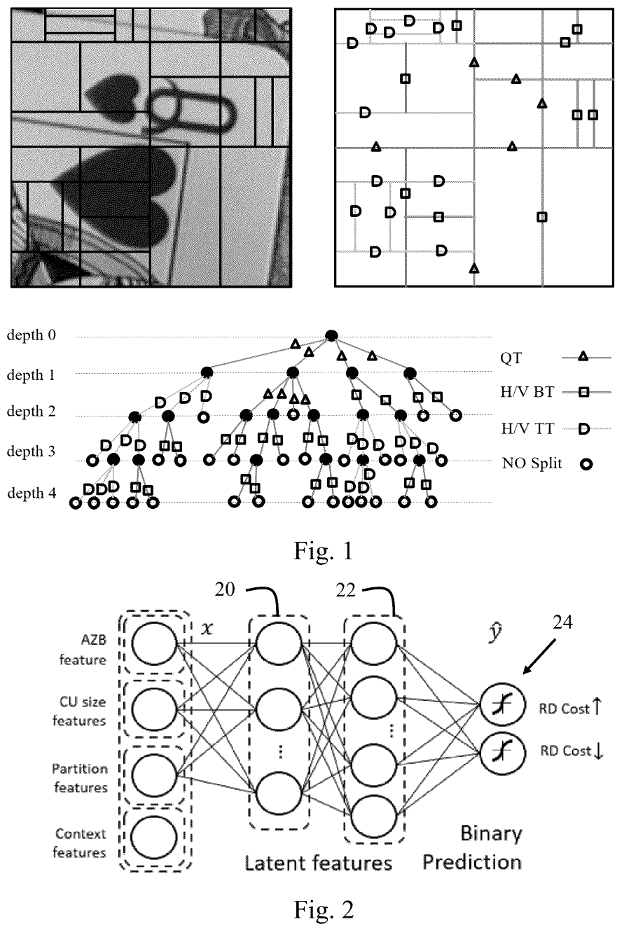

In particular, firstly the MLP model will predict the RD cost associated with QT split in Step 42. If the RD cost as estimated indicates an improved RD performance, then the QT split will be applied to the CU to partition it, and after the partitioning is performed the method will go back to Step 30, and the next iteration of the method will be conducted (thus in a recursive manner). In the next iteration, the method will again perform Steps 30, 32, 34, 36, 40 (and optionally Step 38), and will come to Step 42 again. It is possible that the second prediction for QT split may still indicates an improved RD cost, as a result of which the QT slit will be conducted again (see for example in FIG. 1 where QT partitioning is conducted at more than one depth). In other words, for a given CU, the QT split can be performed once, more than once, or never, using the method of FIG. 3.

No matter if it is the first time or more than one time that Step 42 is performed, if the result of the prediction in Step 42 indicates an improved RD cost, the partitioning using QT split will be performed, and then the method will return to Step 30. On the other hand, if the prediction in Step 42 does not indicate an improved RD cost (e.g., if the RD cost is the same or even worsen), then the method will continue to Step 44 without conducting any further QT split.

The prediction made in Step 44 is to see whether HBT or VBT will result in an improved RD cost, and the process following Step 44 is similar as what is mentioned above for Step 42. If the result of the prediction in Step 44 indicates an improved RD cost, the partitioning using H/V BT split will be performed, and then the method will return to Step 30. On the other hand, if the prediction in Step 44 does not indicate an improved RD cost, then the method will continue to Step 46 without conducting any further H/V BT split.

The prediction made in Step 46 is to see whether HTT or VTT will result in an improved RD cost, and the process following Step 46 is similar as what is mentioned above for Step 42. If the result of the prediction in Step 46 indicates an improved RD cost, the partitioning using H/V TT split will be performed, and then the method will return to Step 30. On the other hand, if the prediction in Step 46 does not indicate an improved RD cost, then the method will continue to Step 48, where the partitioning/encoding of the current CU is finished. The method in FIG. 3 will then start again for the next CU of the frame.

Next, experimental results of the MLP model in FIG. 2 and the method in FIG. 3 (hereinafter “proposed method”) will be discussed. Extensive experiments were conducted using test sequences from common test conditions in H.266/VVC. The coding performance BDBR and encoding time saving TS are evaluated. For experiment purposes, the proposed method was implemented in VVenC [23], which is an optimized encoder of the H.266/VVC. The results are compared with the anchor of VVenC 1.7.0 at slower profile with 20 threads setting. The experiments were conducted on an Intel Core i7 CPU 3.00 GHz processor on an Ubuntu 20.04 desktop computer.

TABLE III
Performance evaluation of the proposed method under different configurations, including
random access (RA), all intra (AI) and low delay (LD). Five classes of sequences are tested.
The BDBR of luma component and correspondence time saving (TS) are presented for
individual sequences. The Overall statistics follow the JVET common test conditions.

| | | AI | | RA | | LD | |
|---|---|---|---|---|---|---|---|
| Class | Sequence | BDBR | TS | BDBR | TS | BDBR | TS |
| A | Tango | 0.57% | 26.06% | 0.96% | 12.48% | 1.48% | 13.91% |
| | FoodMarket | 0.53% | 12.00% | 0.979% | 6.22% | 1.59% | 7.25% |
| | Campfire | 1.40% | 38.34% | 2.10% | 26.01% | 2.01% | 24.66% |
| | CatRobot | 1.72% | 35.09% | 1.20% | 16.30% | 1.24% | 16.73% |
| | DaylightRoad | 1.91% | 37.76% | 1.55% | 17.96% | 1.44% | 18.59% |
| | ParkRunning | 0.58% | 32.68% | 1.13% | 20.06% | 0.77% | 19.89% |
| B | BasketballDrive | 1.45% | 33.89% | 1.49% | 16.50% | 1.35% | 16.85% |
| | BQTerrace | 2.60% | 39.19% | 1.90% | 18.81% | 1.68% | 17.32% |
| | Cactus | 2.03% | 39.35% | 1.49% | 18.41% | 1.22% | 17.66% |
| | MarketPlace | 0.97% | 35.81% | 0.89% | 15.33% | 0.77% | 14.85% |
| | RitualDance | 2.33% | 32.89% | 2.00% | 13.219% | 1.73% | 11.47% |
| C | BasketballDrill | 4.29% | 39.02% | 2.89% | 19.80% | 2.29% | 15.95% |
| | BQMall | 2.44% | 38.50% | 2.33% | 20.50% | 2.02% | 15.32% |
| | PartyScene | 2.46% | 37.04% | 2.43% | 25.70% | 1.90% | 20.22% |
| | RaceHorses | 1.74% | 37.58% | 1.85% | 21.68% | 1.59% | 17.52% |
| D | BasketballPass | 2.55% | 36.08% | 3.14% | 21.82% | 2.08% | 15.16% |
| | BQSquare | 3.64% | 33.16% | 2.74% | 22.03% | 2.339% | 18.77% |
| | BlowingBubbles | 2.48% | 39.13% | 2.09% | 23.38% | 1.43% | 18.67% |
| | RaceHorsesD | 2.63% | 35.42% | 3.14% | 20.51% | 1.98% | 17.22% |
| E | FourPeople | 2.43% | 37.78% | 1.80% | 16.80% | 1.60% | 13.24% |
| | Johnny | 2.30% | 36.76% | 1.72% | 14.70% | 1.54% | 11.17% |
| | KristenAndSara | 2.47% | 36.13% | 2.00% | 13.50% | 1.80% | 11.09% |

| | | | | | | |
|---|---|---|---|---|---|---|
| Class A | 1.12% | 28.35% | 1.32% | 15.10% | 1.42% | 15.77% |
| Class B | 1.88% | 36.13% | 1.55% | 16.32% | 1.35% | 15.66% |
| Class C | 2.73% | 38.04% | 2.38% | 21.95% | 1.95% | 17.28% |
| Class D | 2.83% | 35.98% | 2.78% | 21.94% | 1.95% | 17.47% |
| Class E | 2.40% | 36.90% | 1.84% | 15.01% | 1.65% | 11.84% |
| Overall | 2.03% | 34.63% | 1.75% | 17.55% | 1.65% | 14.74% |

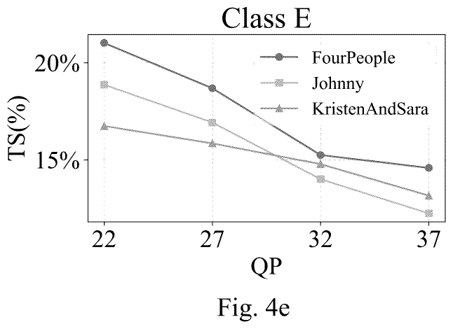

In Table III, the performance evaluation results of the proposed method are presented. Specifically, five classes of sequences from JVET common test condition are tested. Three encoding configurations (AI, RA and LD) are shown to evaluate the encoder's performance under different conditions. Under the AI configuration, the proposed method achieves an average time saving of 34.63% with a BDBR loss of 2.03%. This highlights that the proposed method has enhanced efficiency in intra partition decisions. With the RA configuration, the proposed method achieves an average time saving of 17.55%, at the expense of a 1.75% loss. The BDBR losses are smaller (1.32% and 1.55%) for higher resolution sequences class A and class B with time-saving 15.1% and 16.32%. Under LD configuration, the proposed method achieves 14.74% time saving with 1.65% BDBR loss. In general, the proposed method consistently achieves time savings while maintaining an acceptable loss in RD performance across various configurations. Additionally, the encoding time savings across different QPs of random access configuration from different classes are shown in FIG. 4. This indicates that the proposed method with lower QP achieves more reductions in encoding time compared to higher QPs. In particular, the Campfire sequence from class A demonstrates a 30% time-saving at QP 22, in contrast to a 20% reduction at QP 37. Such phenomenon is consistent across various sequences, indicating that the proposed method is more efficient in speeding up encoding for high bitrate scenarios. This could be attributed to the higher partition depth and higher potential for acceleration under the low QP configurations, as compared to the high QP configuration.

To comprehensively investigate the performance of the proposed method, the proposed model is further compared with a variation. Specifically, a variation without using the AZB feature (w/o AZB Feature) is further tested. Based on (w/o AZB Feature), the AZB detection is further removed (w/o AZB Detection) to highlight the contribution of the partition skipping method. The time-saving to BDBR ratio is utilized as a metric to indicate the level of acceleration achieved with a 1% BDBR loss. The results are shown in Table IV. The time-saving is reported for different classes (class B to class E) representative of varying video coding scenarios. In the RA configuration of class B, a BDBR loss of 1% results in a time-saving of 10.51%, which is greater than the time-saving of 9.12% observed in the version that does not utilize AZB feature and 8.21% without AZB detection. This difference is more obvious in class C and class D. Under the RA configuration for class C, the time savings to BDBR ratio is 9.24%, significantly outperforming the two other versions, which are 5.46% and 5.15%, respectively. This comparison experiment demonstrates that incorporating the AZB feature notably benefits the partition skip mechanism, reinforcing its effectiveness in accelerating the encoding process.

TABLE IV
Time savings and BDBR ratio performance evaluation of the proposed
method and the proposed method w/o utilizing AZB feature.

Random Access

| | | w/o AZB | w/o AZB |
|---|---|---|---|
| CTC Sequence | Proposed | Feature | Detection |
| Class B | 10.51% | 9.12% | 8.21% |
| Class C | 9.24% | 5.46% | 5.15% |
| Class D | 7.90% | 4.67% | 4.57% |
| Class E | 8.15% | 7.54% | 6.62% |

In summary, one can see that the exemplary embodiment described above provides a learning-based fast CU partition decision approach for the H.266/VVC encoder to reduce computational complexity. The method achieves significant complexity reduction among different configurations. The method may be used to optimize the video encoder and reduce the encoding time under the premise of negligible quality loss. The MLP model in the exemplary embodiment uses all-zero block feature to improve the acceleration ratio during encoder optimization. The selected features are discrete features, which is easy to be embedded in the encoder without introducing much computational overhead.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

What is claimed is:

1. A computer-implemented method for making fast partitioning decision on a block of a frame of a video, the method comprising steps of:
a) identifying, for the block, a plurality of partition modes;
b) for one of the plurality of partition modes, predicting a RD (rate-distortion) cost resulted from partitioning the block using the partition mode;
c) performing partitioning using the partition mode, if the RD cost indicates an improved RD performance;
d) skipping the partition mode if the RD cost does not indicate an improved RD performance; and
e) repeating Steps c) and d) for each one of the plurality of partition modes.

2. The computer-implemented method of claim 1, wherein predicting the RD cost in Step b) is based on a plurality of features of the block.

3. The computer-implemented method of claim 2, wherein the block is a coding unit (CU); the plurality of features of the block comprising a AZB (all-zero block) feature, CU size features, partition features, and context features.

4. The computer-implemented method of claim 1, wherein the RD cost is represented in a binary value, which indicates either the improved RD performance or no improvement in RD performance.

5. The computer-implemented method of claim 1, wherein Step b) is conducted using a multilayer perceptron (MLP) model.

6. The computer-implemented method of claim 5, wherein a plurality of features of the block that is contacted as a feature vector, is provided to the MLP model in Step b) as input.

7. The computer-implemented method of claim 5, wherein the MLP model comprises two densely connected layers, with their neuron counts set to 32 and 16 respectively.

8. The computer-implemented method of claim 5, wherein the MLP model is trained using multiple datasets with different quantization parameters.

9. The computer-implemented method of claim 6, wherein all feasible feature combinations of the plurality of features is explored to obtain predictive outcomes, where the predictive outcomes are stored in an video encoder that is adapted to carry out the computer-implemented method.

10. The computer-implemented method of claim 1, wherein the plurality of partition modes includes one or more of quadtree (QT), horizontal binary tree (HBT), vertical binary tree (VBT), horizontal ternary tree (HTT) and vertical ternary tree (VTT).

11. The computer-implemented method of claim 1, further comprises, before Step c), a step of detecting if the block is an AZB.

12. The computer-implemented method of claim 11, further comprises, before the step of step of detecting if the block is an AZB, a step of choosing either an intra-prediction model or an inter-prediction model for encoding the block and generating a residue signal for the step of detecting if the block is an AZB.

13. A non-transitory computer-readable memory recording medium having computer instructions recorded thereon, the computer instructions, when executed on one or more processors, causing the one or more processors to perform operations according to the method according to claim 1.

14. A computing system comprising:
one or more processors; and
memory containing instructions that, when executed by the one or more processors, cause the computing system to perform operations according to the method of claim 1.
